(19) United States
(12) Patent Application Publication
(10) Pub. No.: US 2014/0229851 A1
(43) Pub. Date: Aug. 14, 2014

(54) OUTFITTER SYSTEMS AND METHODS

(71) Applicant: GUIDEFITTER, LLC, Austin, TX (US)

(72) Inventors: BRYAN KOONTZ, Austin, TX (US); Simon Ortet, Toulouse (FR)

(73) Assignee: GUIDEFITTER, LLC, Austin, TX (US)

(21) Appl. No.: 14/178,980

(22) Filed: Feb. 12, 2014

Related U.S. Application Data
(60) Provisional application No. 61/764,664, filed on Feb. 14, 2013.

(51) Int. Cl. G06F 3/0484

(52) U.S. Cl. CPC G06F 3/0484
USPC 715/747

(57) ABSTRACT

Systems and methods for identifying outfitters and/or guides and for generating and maintaining databases including outfitter and/or guide information are disclosed.

### BACKGROUND OF THE INVENTION

Outfitters assist consumers with a variety of outdoor activities such as hunting, fishing, and adventure (e.g., trail riding, whitewater rafting, and camping). An outfitter may assist a consumer in arranging an outdoor activity and/or obtaining the correct supplies for the outdoor activity.

### SUMMARY OF THE INVENTION

The present invention is embodied in methods and apparatus for identifying outfitters and/or guides and generating and maintaining databases including outfitter and/or guide information.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. Also, lines without arrows connecting components may represent a bi-directional exchange between these components. This emphasizes that according to common practice, the various features of the drawings are not drawn to scale. On the contrary, the dimensions of the various features are arbitrarily expanded or reduced for clarity. Included in the drawings are the following figures:

FIG. 1 is a block diagram of an outfitter system in accordance with aspects of the present invention;

FIG. 2 is a block diagram of a computer system for use in the outfitter system of FIG. 1;

FIG. 3 is a flow chart of steps for identifying outfitters in accordance with aspects of the present invention;

FIG. 4 is a flow chart of steps for maintaining a database of outfitter information in accordance with aspects of the present invention;

FIG. 5 is a flow chart of steps for presenting equipment information associated with a guide in accordance with aspects of the present invention;

FIG. 6 is a flow chart of steps for presenting outfitter and game statistics in accordance with aspects of the present invention;

FIG. 7 is a flow chart of steps for updating guide information in accordance with aspects of the present invention;

FIG. 8 is a flow chart of steps for updating season information and/or price lists in accordance with aspects of the present invention;

FIG. 9 is a flow chart of steps for managing outfitter/guide calendars and booking outfitter/guide services online in accordance with aspects of the present invention;

FIG. 10 is a flow chart of steps for performing outfitter drip marketing in accordance with aspects of the present invention;

FIG. 11A is a top half and FIG. 11B is a bottom half of a graphical user interface (GUI) for use by an outfitter/guide to set up a profile in accordance with aspects of the present invention;

FIG. 12A is a top half and FIG. 12B is a bottom half of a GUI for use by an outfitter/guide to set up product offering and pricing for particular specialties in accordance with aspects of the present invention;

FIG. 13 is a GUI for use by a consumer to identify initial criteria for selecting an outfitter/guide in accordance with aspects of the present invention; and

FIG. 14 is a GUI for use by a consumer to review outfitters selected based on initial criteria and further refine outfitter selection based on additional criteria selection options in accordance with aspects of the present invention.

### DETAILED DESCRIPTION OF THE INVENTION

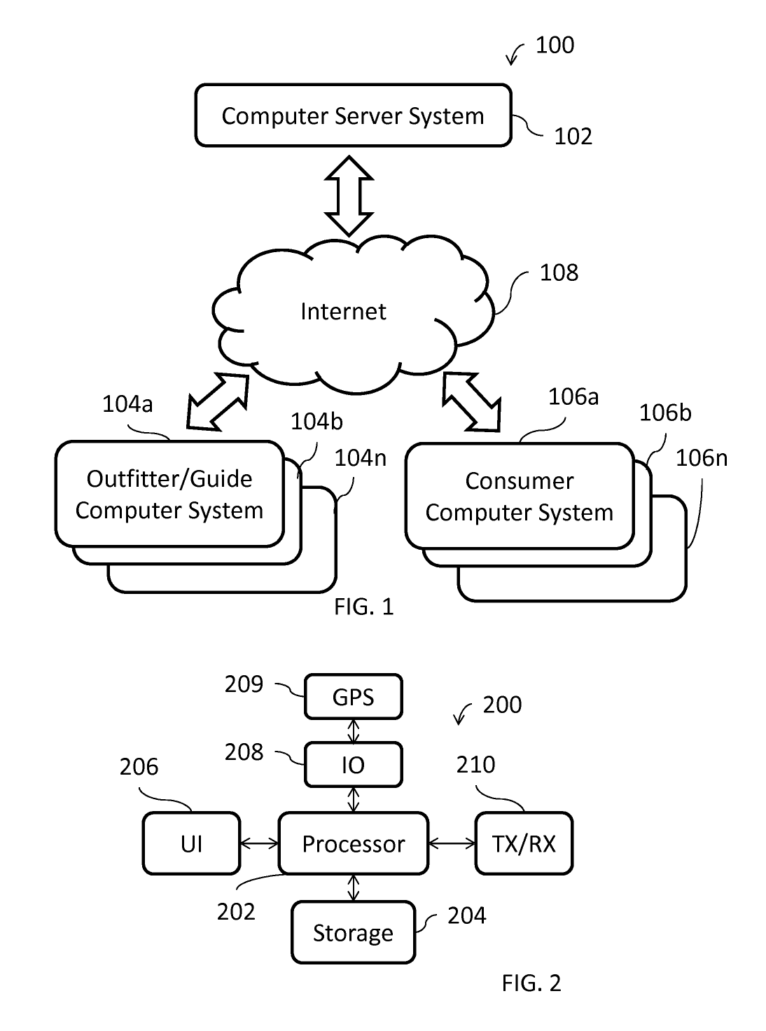

FIG. 1 depicts a system 100 for identifying outfitters. As used herein, the term “outfitter” refers to a business entity that assists consumers with outdoor activities such as hunting, fishing, and/or adventure activities (hiking, kayaking, etc.). An outfitter may be associated with one or more guides that help consumers with the outdoor activities.

The system 100 includes a computer server system 102 that stores data associated with the outfitters and, optionally, guides; an outfitter/guide computer system 104 that outfitters/guides use to communicate with computer server system 102, e.g., to provide data related to their business and receive inquiries from customers; and a consumer computer system 106 that communicates with the computer server system 102, e.g., to initiate outfitter inquires, purchase outfitter/guide product offerings, and update personal information. The computer systems may communicate with each other via a network such as the Internet 108 in the illustrated embodiment.

In an exemplary implementation, the system 100 is an outfitter identification system that enables consumer to identify outfitters for particular activities the consumer would like to participate in. For example, the system 100 may be used by a consumer to identify a 5-day Elk hunt in Alaska, a 3-day fishing trip in Brazil, or a family dude ranch experience in Montana.

FIG. 2 depicts exemplary components of a computer system 200 for use as computer systems 102/104/106 of FIG. 1. Each computer system 200 includes a processor 202 for processing instructions and storage 204 with which the processor 202 communicates. Storage 204 includes instructions for configuring the computer systems when executed by the processor to provide the functionality of its respective computer system. The computer systems additionally include a user interface (UI) 206 that can be employed by a user of a computer system to interact with that computer systems and a transmitter and/or transceiver (TX/RX) 210 for communicating with other computer systems over a network such as the Internet 108 (FIG. 1) in the illustrated embodiment. One or more of the computer systems may include input and/or output devices/ports (IO) 208 for receiving data from an external source (e.g., a global positioning system 209, a microphone (not shown), or a video camera (not shown)). Suitable processors 202, storage 204, UI 206, IO 208 and TX/RX 210 will be understood by one of skill in the art from the description herein.

For the computer server system 102, the computer system 200 may be a conventional computer system or collection of conventional systems. In an embodiment where the computer server system 102 is a conventional computer, the processor 202, storage 204, UI 206, IO 208, and TX/RX 210 may be components commonly found in such system. Other suitable computer systems/components for use as the computer system 200 will be understood by one of skill in the art from the description herein. For example, the computer server system 102 may be a distributed system comprising one or more processors 202 and one or more storage components 204.

For the outfitter/guide computer system 104, the computer system 200 may be a conventional computer system such as a desktop computer, a portable computer system (e.g., a laptop computer), or a mobile device (e.g., an iPhone available from Apple, Inc. of Cupertino, Calif.). The computer system 200 may include a processor 202, storage 204, UI 206, IO 208, and TX/RX 210 commonly found in such conventional computer system. The UI 206 may be a conventional keypad, mouse, touchpad, and/or display, the IO 208 may be a conventional camera and/or microphone, and the TX/RX 210 may be a conventional transceiver such as a modem, cellular transceiver and/or network interface for accessing a network connected to the Internet. The IO 208 may additionally include a port(s) for receiving information from external data sources such as audio and/or video recording equipment. Software for configuring such systems for use in accordance with the present invention may be downloaded from the computer server system 102 and/or from another site such as the Apple App store maintained by Apple Inc. of Cupertino, Calif. Other suitable computer systems/components for use as the computer system 200 will be understood by one of skill in the art from the description herein.

For the consumer computer system 106, the computer system 200 may be a home computer system, a portable computer system, or a mobile device such as a cellular telephone (e.g., an iPhone available from Apple, Inc. of Cupertino, Calif.). In an embodiment where the consumer computer system 106 is a cellular telephone, the processor 202, storage 204, UI 206, IO 208, and TX/RX 210 may be components commonly found in a conventional cellular telephone. The UI 206 may be a conventional keypad and/or display, the IO 208 may be a conventional camera and/or microphone, and the TX/RX 210 may be a conventional cellular transceiver and/or network interface for accessing a network connected to the Internet. Software for configuring such systems for use in accordance with the present invention may be downloaded from the computer server system 102 and/or from another site such as the Apple App Store maintained by Apple Inc. of Cupertino, Calif. Other suitable computer systems/components for use as the computer system 200 will be understood by one of skill in the art from the description herein.

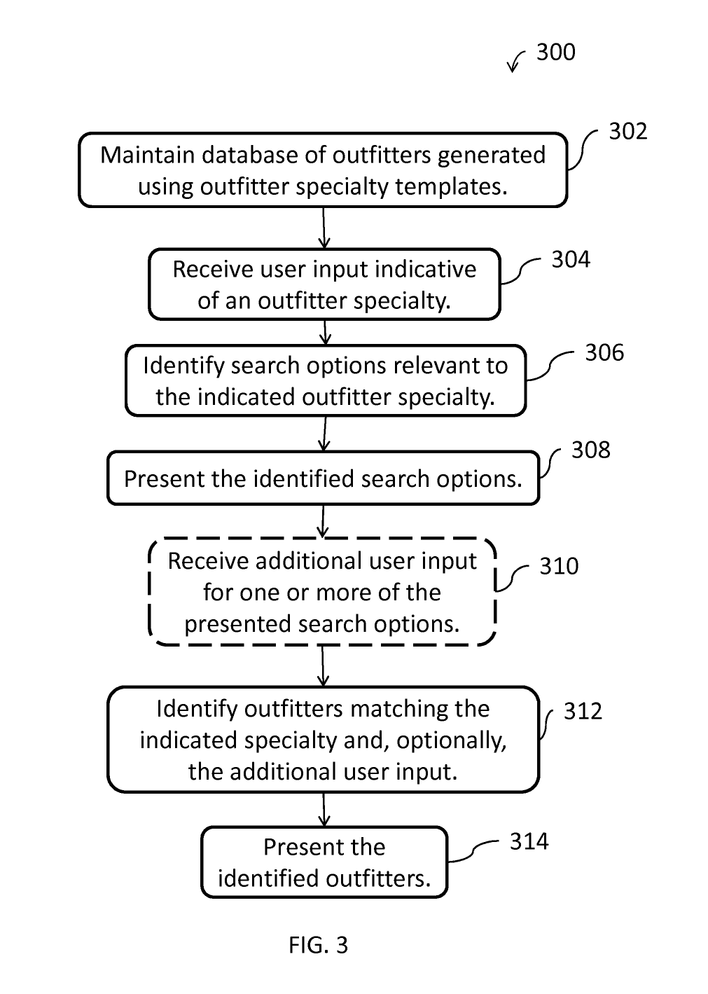

FIG. 3 depicts a flow chart 300 of steps for identifying outfitters. The steps of flow chart 300 and the other flow charts depicted and described herein are described with reference to the computer systems 102/104/106 depicted in FIGS. 1 and 2 to facilitate description. Other computer systems for use with the present invention will be understood by one of skill in the art from the description herein. It will be understood the one or more of the steps may be performed in a different order than as depicted (including simultaneously) or may be omitted without departing from the spirit and scope of the present invention.

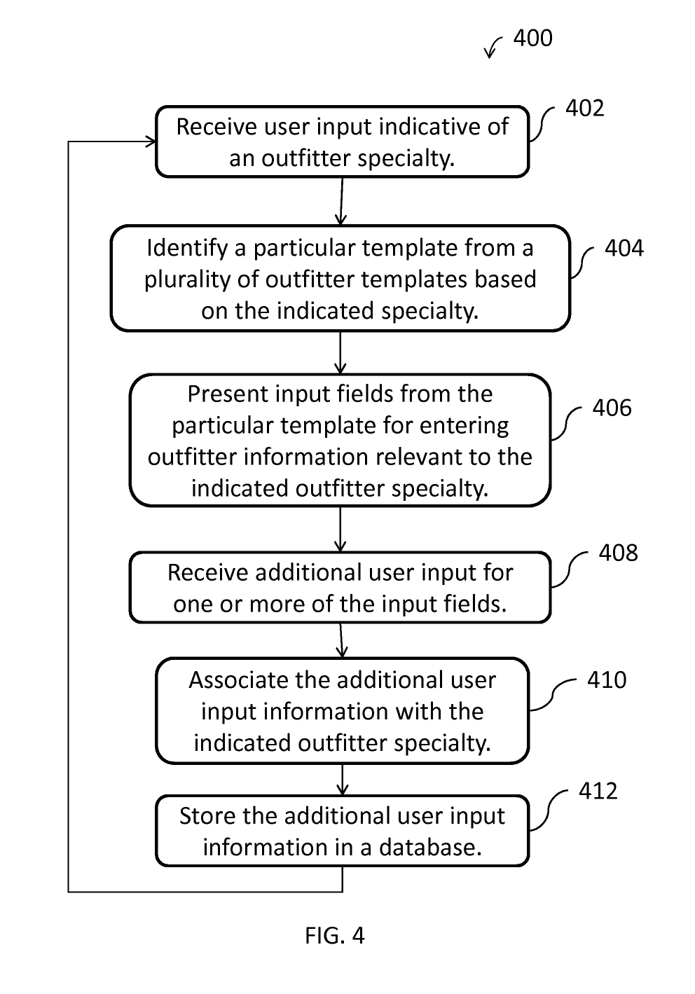

At block 302 a database of outfitters is maintained. The database is generated using outfitter specialty templates. The database may be maintained by processor 202 of computer server system 102, e.g., in storage 204. Additional details regarding generation and maintenance of the database are provided below with reference to FIG. 4.

In an exemplary embodiment, a “specialty” such as that captured using the outfitter specialty templates may include: (1) Categorization of the animal from a game management/hunting/conservation point of view—e.g., “Big Game” or “Varmint” or “Waterfowl” etc., (2) Classification of the animal from a scientific point of view, describing a species/subspecies taxonomy—e.g., “Elk>Rocky Mountain elk” or “Bear>Brown Bear” etc. and/or a seasonal phase of a species, e.g., the “color phase” of a black bear, which may be black, brown, cinnamon, blond, blue-gray, or white.; (3) Enumeration of the features and options available to a sportsperson for this particular outdoor sporting activity—e.g., lodging options, transportation options, weapon choices, etc., and (4) Pricing information related to the unique configuration of the categorization, classification, and enumeration. This unique data taxonomy enables providing, for example, search capability at an animal species level and/or subspecies level, while having either the species OR a subspecies be associated with a particular game management category. This enables the particular kinds of features/options typically associated with that game management category to be defined, e.g., for the selected animal species' and/or subspecies', which, in turn, enables detailing all the related pricing details that may be specific to that game management category, that animal, and for the selected features/options.

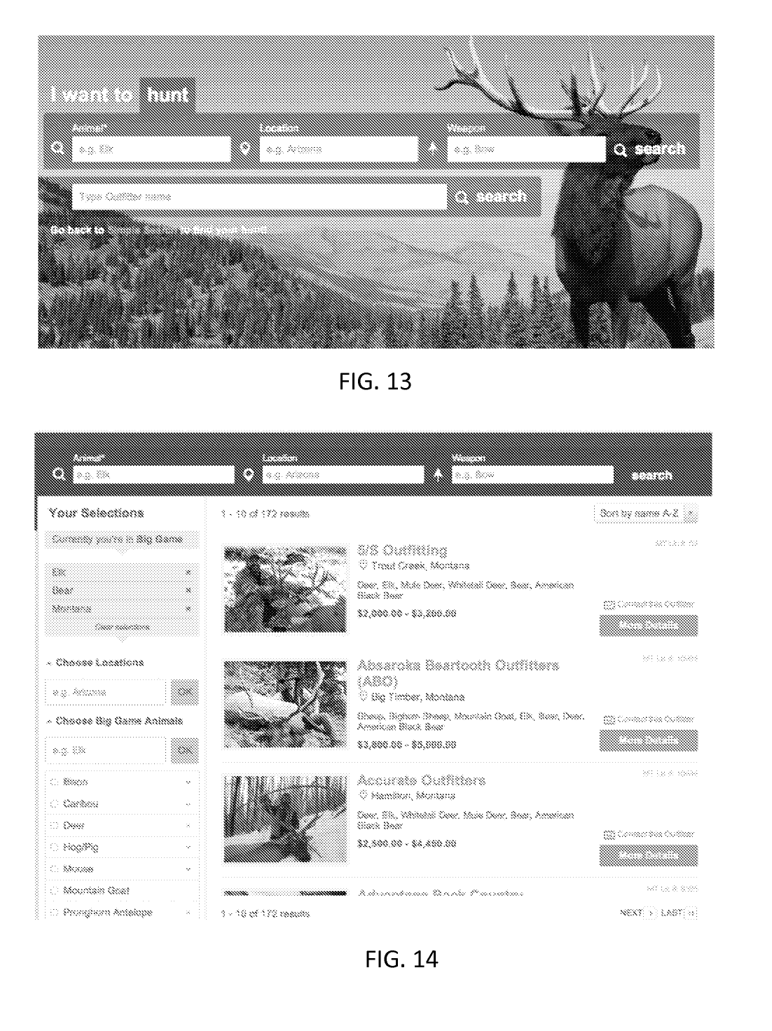

At block 304, user input that is indicative of an outfitter specialty is received. The user input may be received by computer server system 102, e.g., from consumer computer system 106 via the Internet. FIG. 13 depicts an exemplary interface that may be displayed as a web page on consumer computer system 106 to receive user input.

In one embodiment, user input may be received via selectable text. The selectable text may be served by computer server system 102 for display by consumer computer system 106. Text may be selectable through the use of text that is selectable by moving a pointing device (e.g., a mouse pointer) over the text to be selected and/or radio buttons, drop down, menus, and/or tabs associated with the text.

Single or multiple levels of user input may be employed to receive a user input indicative of an outfitter specialty. In a single level system, the specialty, such Elk Hunting in Montana may be displayed on an initial web page served by computer server system 102 and viewed on consumer computer system 106. In a multiple level system, the specialty may be accessed by first presenting one or more higher-level selection categories. For example, an initial page may present a user with the option to select for the following categories: “Hunting,” “Fishing,” or “Adventure.” Selection of one of these categories may result in presentation of additional sub-categories. For example, if “Hunting” is selected, another page may present a user with the option to select from the following sub-categories: “Elk,” “Bear,” “Fox,” “Birds.” Selection of one of these sub-categories may result in presentation of additional sub-sub-categories. For example, if “Birds” is selected, another page may present a user with the option to select from the following sub-categories: “Ducks,” “Geese,” “Waterfowl.” In another example, a three-level hierarchy may be employed such as outfitting category (e.g., “Hunting”), animal species (e.g. “Elk”), animal subspecies (e.g. “Rocky Mountain Elk). Additional levels may be employed depending on the level of granularity desired.

In another embodiment, user input may be received via a text box. For example, a consumer may type “I want to fish for Tuna in the Atlantic.” in a text box displayed on their computer. This text may be processed by processor 202 of computer server system 102 using a natural language processing (NLP) algorithm to identify an outfitter specialty corresponding to the text input by the user.

At block 306, search options relevant to the indicated specialty are identified. The processor 202 of computer server system 102 may identify the search options by matching the outfitter specialty indicated by the selections received at block 304 to search options in templates corresponding to the indicated specialty.

At block 308, the identified search options are presented to the user, e.g., for selection to refine the search. The processor 202 of computer server system 102 may serve a web page including the identified search options for viewing on a consumer computer system 106 by the user. FIG. 14 depicts an exemplary web page including additional search options.

At block 310, additional user input is optionally received. The additional user input may be received by computer server system 102, e.g., from consumer computer system 106 via the Internet. For example, a user may check a box next to one of the search options depicted in FIG. 14.

At block 312, outfitters matching the indicated specialty and, optionally, the additional user input are identified. The processor 202 of computer server system 102 may identify the outfitters by matching specialties identified by the outfitter (which are stored in the database) to the outfitter specialty indicated by the selections received at blocks 304 and, optionally, block 310 (e.g., Animal=Elk, State=Any, Weapon=Any).

At block 314, the identified outfitters are presented to the user, e.g., for selection. The processor 202 of computer server system 102 may serve a web page including the identified outfitters for viewing on a consumer computer system 106 by the user. The presented outfitter information may include the outfitters name (e.g., LOH Outfitters, Rawhide guide Service, 2CR Outfitters, etc.). The presented information may include additional details about the outfitters (e.g., types of hunts) and/or links to additional information (e.g., contact information). Additionally, professional licensing information associated with the identified outfitters may be presented. FIG. 14 depicts an exemplary web page including identified outfitters.

In one embodiment, specific products and/or services offered by the outfitters may be presented to the user in addition to or instead of the identified outfitter information described in the preceding paragraphs. In accordance with this embodiment, specific product and/or service information (e.g., $2,500—5 Day Elk Hunt—2:1 Guide—Montana (LOH Outfitters); $3,500—5 Day Elk Hunt—1:1 Guide (LOH Outfitters); $3,200—Elk/Deer Combo Hunt—2:1 Guide—Colorado (Rawhide Guide Service); and $1,845—3 Day Elk Hunt—New Mexico (2CR Outfitters)) may be presented. Additionally, links may be provided to product/service detail pages that provide more information about each specific product/service, which may be located on an outfitter profile page. In accordance with these embodiments, the steps described above for block 312 may be modified to identify specific products and/or services matching the indicated specialty and, optionally, the additional user input; and the steps of block 314 may be modified to present the identified products and/or services in addition to or instead of the outfitter information.

FIG. 4 is a flow chart 400 of exemplary steps for generating and maintaining a database of outfitter information.

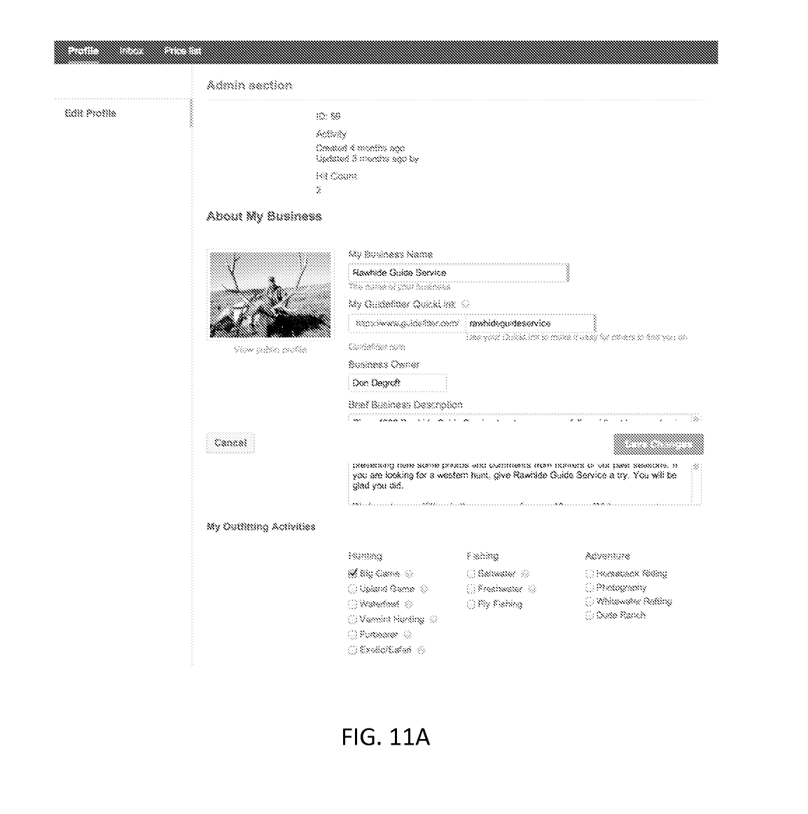

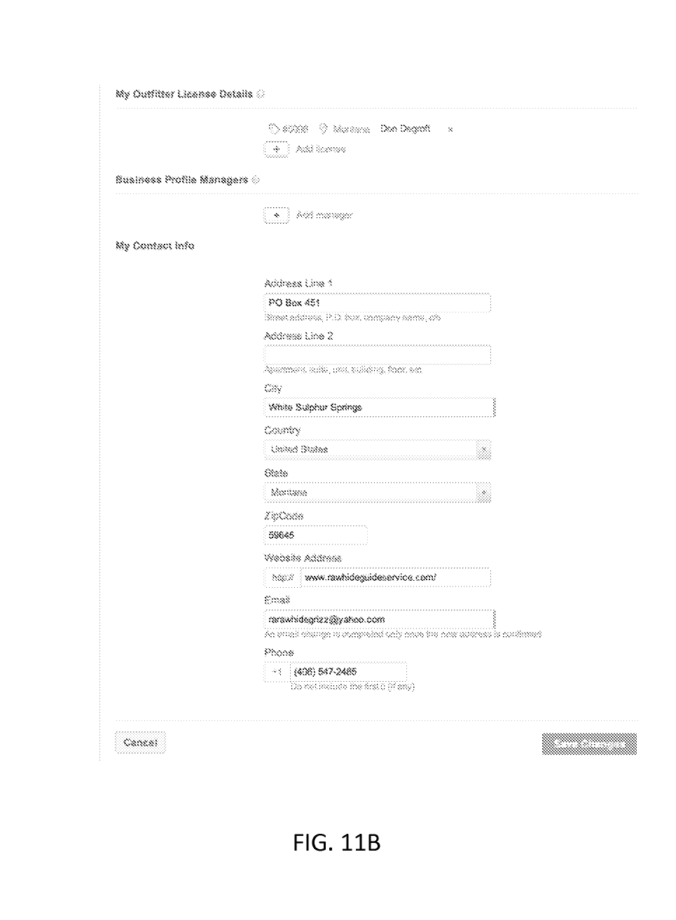

At block 402, user input indicative of an outfitter specialty is received. The user input may be received from a representative of an outfitter and/or guide (or another acting on their behalf, e.g., a system administrator of the computer server system 102) by computer server system 102, e.g., from outfitter/guide computer system 104 via the Internet. FIGS. 11A and 11B depict a web page of input fields for use by an outfitter guide to set up their profile and identify one or more specialties in accordance with one embodiment. In other embodiments, selection of outfitter specialties and product definitions may be made using a separate web page(s) after a profile is set up.

In one embodiment, user input may be received via selectable text. The selectable text may be served by computer server system 102 for display by consumer computer system 106. Text may be selectable through the use of text that is selectable by moving a pointing device (e.g., a mouse pointer) over the text to be selected and/or radio buttons, drop down, menus, and/or tabs associated with the text.

Single or multiple levels of user input may be employed to receive a user input indicative of an outfitter specialty. In a single level system, the specialty, such Elk Hunting in Montana may be displayed on an initial web page served by computer server system 102 and viewed on consumer computer system 106. In a multiple level system, the specialty may be accessed by first presenting one or more higher level selection categories. For example, an initial page may present a user with the option to select for the following categories: “Hunting,” “Fishing,” or “Adventure.” Selection of one of these categories may result in presentation of additional sub-categories. For example, if “Hunting” is selected, another page may present a user with the option to select from the following sub-categories: “Elk,” “Bear,” “Fox,” “Birds.” Selection of one of these sub-categories may result in presentation of additional sub-sub-categories. For example, if “Birds” is selected, another page may present a user with the option to select from the following sub-categories: “Ducks,” “Geese,” “Waterfowl.”

At block 404, a particular template is identified from a plurality of outfitter templates based on the indicated outfitter specialty. A processor 202 of computer server system 102 may identify the template by matching the indicated outfitter specialty received at block 202 to outfitter specialty information associated with the templates to identify a match. The plurality of templates may be stored in storage 204 of computer server system 102.

In an embodiment, each of the templates corresponds to a particular outfitter specialty and includes outfitter information fields that are unique to that particular outfitter specialty. Exemplary templates include, by way of non-limiting example, big game hunting, waterfowl hunting, salt water fishing, etc.

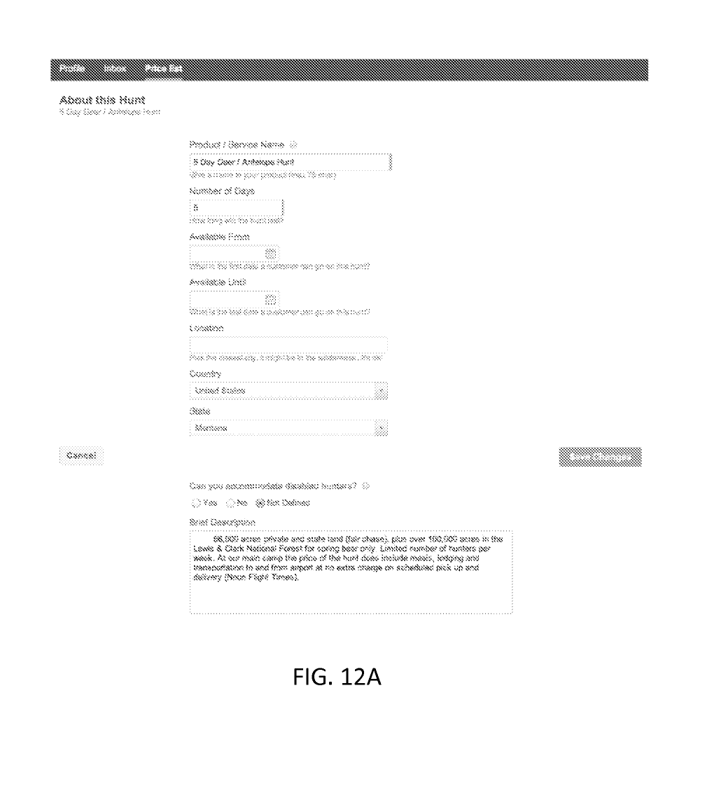

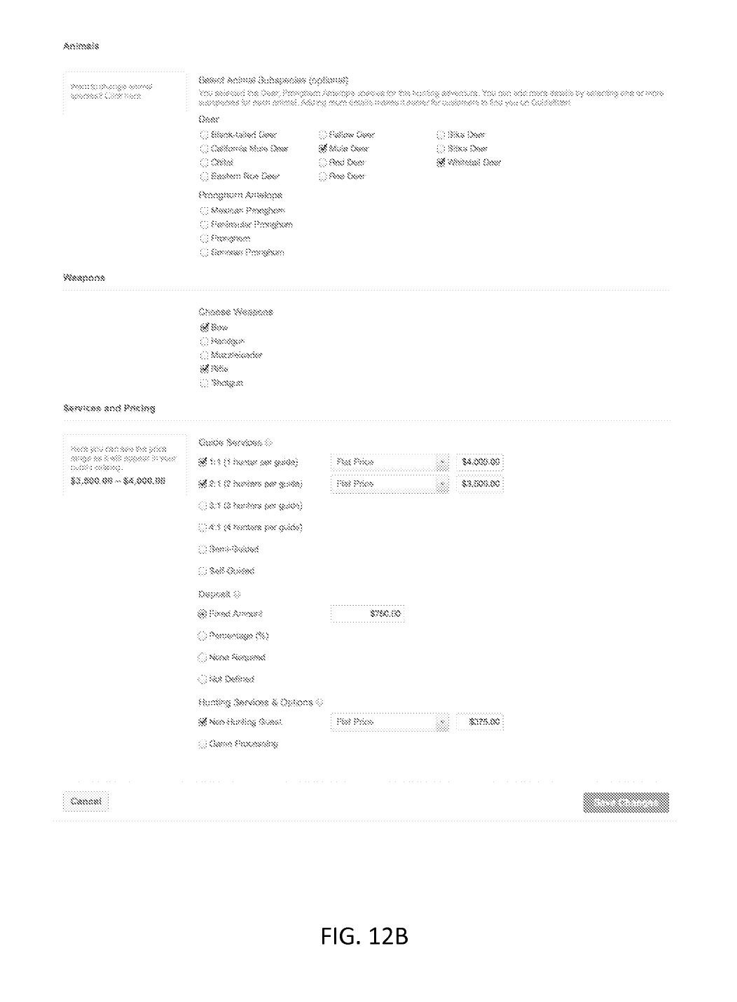

At block 406, input fields for the particular template identified in block 404 are presented and, at block 408, additional user input is received via these input fields. The input fields correspond to data fields in the particular template. The processor 202 of computer server system 102 may serve a webpage including the input fields for display on the outfitter/guide computer system 104 and may receive user input inserted into these fields. FIGS. 12A and 12B depict a web page of input fields for collecting information associated with a “Big Game” template for use by an outfitter/guide to define a product offering. Using the input fields associated with the particular template, an outfitter/guide can identify particular products that are available from the outfitter with particular specificity, such as the various pricing details of a week-long mule deer hunt in Montana. The input fields may be text boxes, radio buttons associated with particular text, drop down menus, or essentially any technique for receiving user input.

At block 410, the additional user input information is associated with the outfitter specialty and, at block 412, the additional user input is stored. The processor 202 of computer server system 102 may associate the input information with the outfitters specialty and store the additional user input in a database, e.g., in storage 204 of computer server system 102.

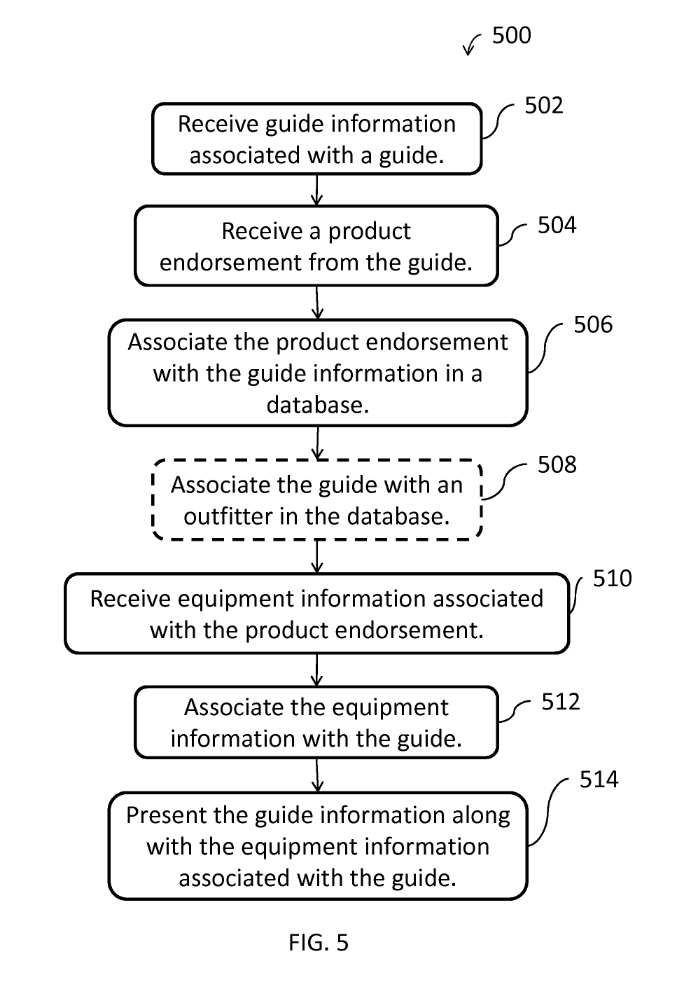

FIG. 5 depicts a flow chart 500 of steps for presenting guide information along with equipment information such as original equipment (OEM) information. The guide information is information identifying a guide and providing details about the guide, e.g., area of expertise, experience level, etc. The OEM information may include additional information on products, web links to additional information on products, and/or links to purchase products.

At block 502, guide information associated with a guide is received. The guide information may be received by processor 202 of computer server system 102 from a user of an outfitter/guide computer system 104. The user may be the guide himself/herself, a user associated with the guide, and/or a user associated with an outfitter that employs the guide.

At block 504, a product endorsement for a product is received from a guide. The guide information may be received by processor 202 of computer server system 102 from a user of an outfitter/guide computer system 104. The user may be the guide himself/herself or a user acting at the direction of the guide. The product endorsement may include a recommendation to buy the product and/or a rating of product.

At block 506, the product endorsement received at block 504 is associated with the guide information received at block 502. The product endorsement may be associated with the guide information by processor 202 of computer server system 102.

At block 508, the guide is optionally associated with the outfitter in the database. The guide may be associated with an outfitter by processor 202 of computer server system 102. In embodiments where the guide is independently operating or operating outside of his/her relationship with an outfitter, this step may be omitted.

At block 510, equipment information associated with the product endorsement is received. The equipment information may be received by a processor 202 of computer server system 102 from a user such as a representative of an original equipment manufacturer (OEM). The equipment information may include descriptive information corresponding to the product and/or information for buying the product such as a web link to a purchasing site.

At block 512, the equipment information received at block 510 is associated with a guide. The equipment information may be associated with a guide by processor 202 of computer server system 102.

At block 514, the guide information is presented along with the equipment information associated with the guide. The processor 202 of computer server system 102 may present the information as a web page for display on user computer system 106. For example, the information may be displayed in a virtual “Gear Room” and a user can “click” on a product in the Gear Room to see additional information and/or make a purchase. This enables a consumer to see a guide's endorsement and, thus, be more confident in purchasing the endorsed product.

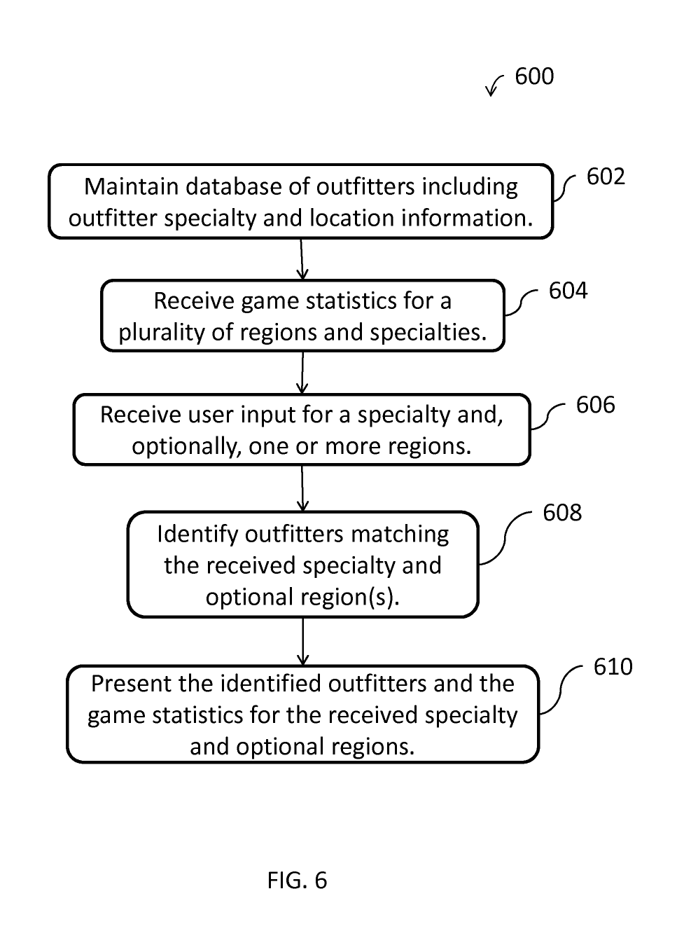

FIG. 6 depicts a flow chart 600 of steps for presenting outfitters and game statistics. At block 602 a database of outfitters is maintained that includes the outfitter's specialty(ies) and location information. The database may be generated using outfitter specialty templates, such as described above with reference to FIG. 4, that includes location information as a field. The database may be maintained by processor 202 of computer server system 102, e.g., in storage 204.

At block 604, game statics for a plurality of regions and specialties are received. The game statistics may be received by processor 202 of computer server system 102. The processor 202 may receive the game statistics from state maintained databases, e.g, “Game Management Unit” or “Wildlife Management Unit,” that identify harvest statistics by regions, for example.

At block 606, user input is received for a specialty and, optionally, one or more regions. The user input may be received by processor 202 of computer server system 102 from a user of a consumer computer system 106.

At block 608, outfitters matching the received specialty and optional region(s) are identified. The processor 202 of computer server system 102 may identify the outfitters by matching specialties (and optionally regions) identified by the user with the outfitter's information stored in the database.

At block 610, the identified outfitters are presented to the user along with game statistics for the received specialty and optional regions. The processor 202 of computer server system 102 may serve a web page including the identified outfitters for viewing on a consumer computer system 106 by the user. This enables the user to perform “virtual scouting” by comparing the game statistics for a location with the outfitter's products/services in those same areas, which is useful when making purchasing decisions regarding an outfitter's product/service offerings.

In one embodiment, the products/services (e.g. a “hunt”) associated with the identified outfitters may be displayed on a graphical map showing a specific region (Game Management Unit or Wildlife Management Unit) in which the product/service would take place. The map may show the game statistics for these regions as well, enabling the consumer to better assess the suitability of a given region(s) for the desired activity. For example, if the consumer knows “Unit 16” in New Mexico is a great area for trophy elk, based on historical animal harvest statistics from the state, they may target specific outfitters who operate in Unit 16.

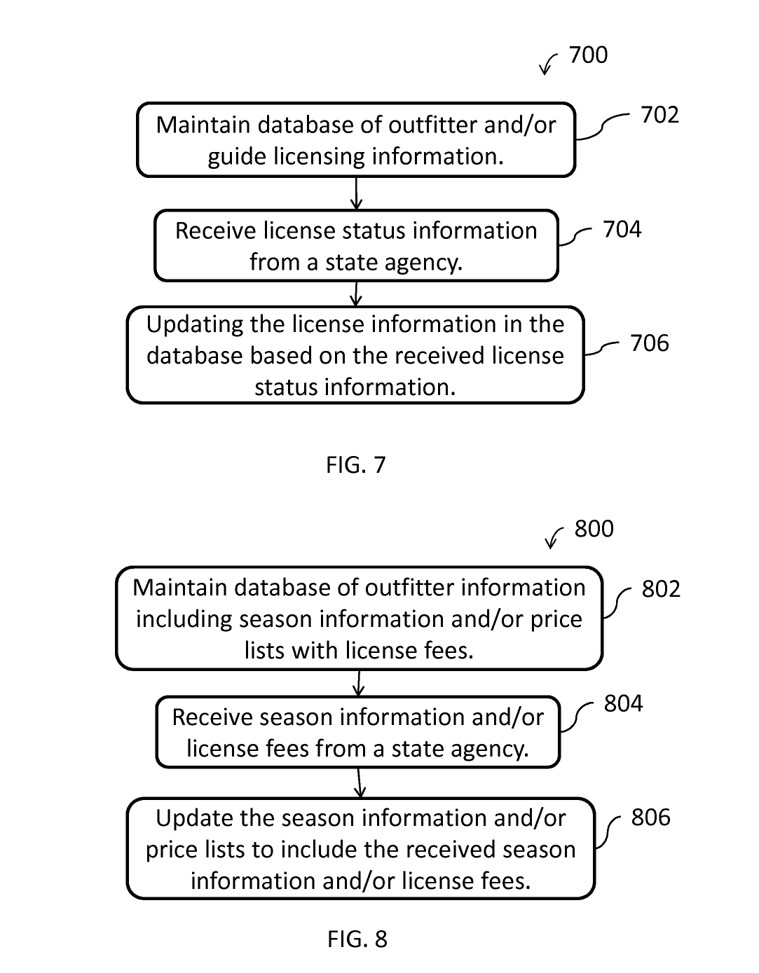

FIG. 7 depicts a flow chart 700 of steps for automatically updating guide license information. This enables a user to identify whether and outfitter's license is current, which provides a level of confidence in selecting an outfitter/guide. The licensing information associated with a guide may be a filter criteria so that a user may specify, for example, “Only show me outfitters with a valid license in good standing.”

At block 702, a database of outfitter and/or guide license information is maintained. The database may be maintained by processor 202 of computer server system 102, e.g., in storage 204.

At block 704, outfitter and/or guide information is received from one or more state and/or government agencies. The information may be received by periodically polling agency maintained database including outfitter and/or guide information. Processor 202 of computer server system 102 may poll the agencies and receive the outfitter and/or guide information.

At block 706, the license information received in block 704 is used to update the database of outfitter and/or guide license information. Processor 202 of computer server system 102 may update the database. In an exemplary embodiment, the license information is presented to consumers when they are viewing outfitters and/or guides and may be a search criteria for identifying outfitters and/or guides with whom they want to do business.

FIG. 8 depicts a flow chart 800 of steps for automatically updating season information and/or price lists. The state-provided season information is made available to users within the application to help users specify product/service and pricing information. The “specialty templates” can reference this state-provided data and provide guidance to users who are specifying dates, animals, etc.

At block 802 a database of outfitter information is maintained that includes season information and/or price lists with license fees. The database may be maintained by processor 202 of computer server system 102, e.g., in storage 204.

At block 804, season information and/or license fees are received from one or more state and/or government agencies. The information may be received by periodically polling agency maintained database including season information and/or price information. Processor 202 of computer server system 102 may poll the agencies and receive the season and/or price information.

At block 806, the season and/or price information received in block 804 is used to update the database of outfitter information. Processor 202 of computer server system 102 may update the database. In an exemplary embodiment, the season and/or price information is presented to consumers when they are viewing outfitters and/or guides and/or is searchable. This provides consumers with valuable information that may be useful when determining they type of activity they are interested in pursuing.

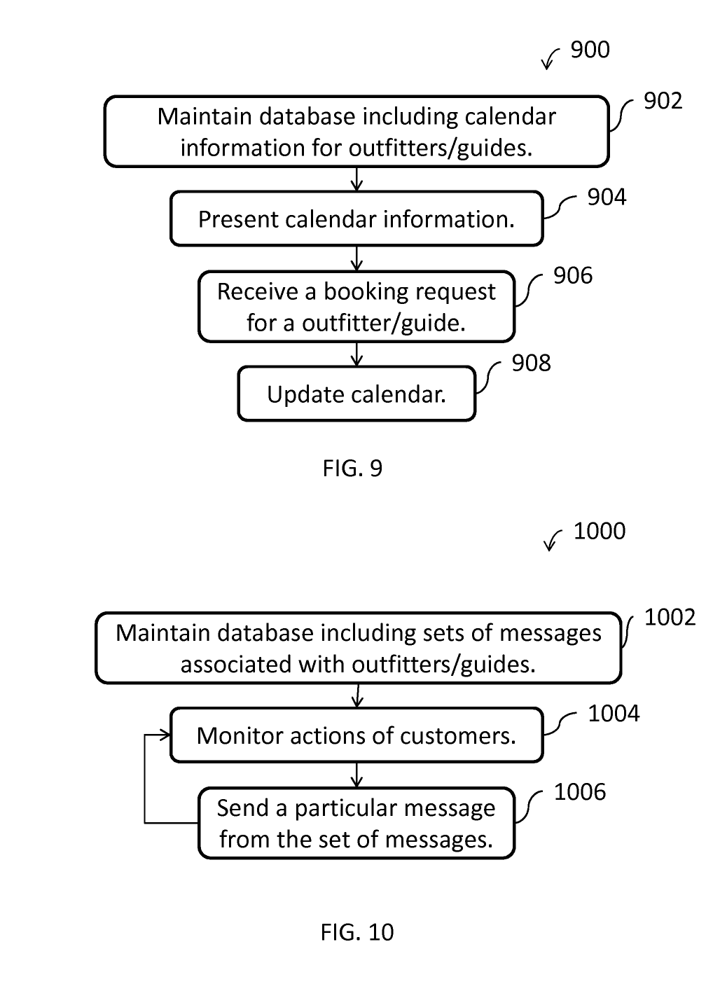

FIG. 9 depicts a flow chart 900 of steps for calendar management and online booking. At block 902, a database including calendar information (e.g., availability) for outfitters/guides is maintained. The database may be maintained by processor 202 of computer server system 102, e.g., in storage 204. At block 904, calendar information for one or more guides is presented, e.g., in response to a consumer selecting of the one or more guides. Processor 202 of computer server system 102 may present the calendar information, e.g., as part of a web page accessed by a consumer computer system 106. At block 906, a booking request is received to book a particular time slot of an outfitter/guide. Processor 202 of computer server system 102 may receive the booking request, e.g., through a consumer portal of a web page accessed by the consumer computer system 106. At block 908, the calendar maintained at block 902 is updated. Processor 202 of computer server system 102 may update the calendar, preferably in real time.

FIG. 10 depicts a flow chart 1000 of steps for drip marketing. At block 1002, a database including sets of messages associated with outfitters and/or guides are maintained. The database may be maintained by processor 202 of computer server system 102, e.g., in storage 204. At block 1004, actions of consumers are monitored. For example, processor 202 of computer server system 102 may monitor how often and/or how long consumer computer system 106 accessed computer server system 102. At block 1006, a message is sent to the consumer. The message may be selected and sent based on the monitored actions. Processor 202 of computer server system 102 may select a message and send it to the consumer based on the consumer's actions. For example, a message may be sent every half hour a user is accessing the computer server system, every five times they access the computer server system, or after a period of not accessing (e.g., one week). The steps in blocks 1004 and 1006 may repeat with different messages provided in response to different actions. The messages may be email marketing, although other media can also be used.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for identifying outfitters, the method comprising:
maintaining a database of outfitters generated using outfitter specialty templates, each outfitter associated with outfitter specialty information;
receiving user input indicative of an outfitter specialty;
identifying outfitters using a computer server system by matching the indicated outfitter specialty to the outfitter specialty information; and
presenting information about the identified outfitters.

2. The method of claim 1, wherein the outfitter specialty templates (1) categorize the animal, (2) classify the animal, (3) enumerate features and options available to a sportsperson, and (4) provide pricing information related to the unique configuration of the categorization, classification, and enumeration.

3. The method of claim 1, further comprising:
identifying, with a processor, outfitter search options relevant to the indicated outfitter specialty; and
receiving user input for the identified outfitter search options;
wherein the outfitters are identified by also matching the user input for the identified outfitter search options to the outfitter specialty information.

4. The method of claim 3, wherein the outfitter search options include at least one of a species selection option or a subspecies selection option.

5. The method of claim 4, wherein the step of receiving user input for the identified outfitter search options includes;
receiving a user input species election corresponding to the species selection option or a user input subspecies election corresponding to the subspecies selection option.

6. The method of claim 1, further comprising:
presenting information from the database of outfitters as selectable text;
wherein the user input of the outfitter specialty is received via the selectable text.

7. The method of claim 1, further comprising:
presenting a text input field for receiving user input;
wherein the user input of the outfitter specialty is received via the text input field.

8. The method of claim 7, wherein the identifying step further comprises:
using a natural language processing (NLP) algorithm to identity the outfitter specialty corresponding to the user input.

9. The method of claim 1, wherein the presented information includes the names of the identified outfitters.

10. The method of claim 9, wherein the presented information includes licensing information for at least one of the identified outfitters.

11. The method of claim 1, further comprising:
associating a guide with an outfitter in the database.

12. The method of claim 11, further comprising:
receiving information associated with the guide;
receiving an endorsement of a product from the guide; and
associating, by the computer server system, the received product endorsement with the received guide information.

13. The method of claim 12, further comprising:
receiving equipment information associated with the product;
associating the equipment information with the guide; and
presenting the guide information along with the equipment information associated with the guide.

14. The method of claim 1, wherein the database also includes location information and wherein the method further comprises:
receiving game statistics for a plurality of regions;
presenting the game statistics along with the information about the identified outfitters.

15. A system for identifying outfitters, the system comprising:
a storage component; and
a processor configured to maintain a database of outfitters generated using outfitter specialty templates in the storage component, each outfitter associated with outfitter specialty information; receive user input indicative of an outfitter specialty; identify outfitters by matching the indicated specialty to the outfitter specialty information; and present information about the identified outfitters.

16. The system of claim 15, wherein the outfitter specialty templates (1) categorize the animal, (2) classify the animal, (3) enumerate features and options available to a sportsperson, and (4) provide pricing information related to the unique configuration of the categorization, classification, and enumeration.

17. The system of claim 15, wherein the processor is further configured to identify outfitter search options relevant to the indicated outfitter specialty and receive user input for the identified outfitter search options, wherein the outfitters are identified by also matching the user input for the identified outfitter search options to the outfitter specialty information.

18. A method for maintaining a database of outfitter information, the method comprising;
receiving user input indicative of an outfitter specialty;
identifying a particular template from a plurality of outfitter templates with a processor by matching the indicated specialty to a specialty identifier associated with the template;
presenting input fields from the particular templates for entering outfitter information relevant to the indicated outfitter specialty;
receiving additional user input for one or more of the input fields;
associating the additional user input outfitter information with the indicated outfitter specialty; and
storing the additional user input information in a database.

19. The method of claim 18, wherein each of the plurality of templates corresponds to a particular outfitter specialty and includes outfitter information fields that are unique to the particular outfitter specialty.

20. A system for maintaining a database of outfitter information, the system comprising:
a storage component; and
a processor configured to receive user input indicative of an outfitter specialty, identify a particular template from a plurality of outfitter templates; present input fields from the particular templates for entering outfitter information relevant to the indicated outfitter specialty, receive additional user input for one or more of the input fields, associating the additional user input outfitter information with the indicated outfitter specialty, and store the additional user input information in a database.
